(19) United States
(12) Patent Application Publication
(10) Pub. No.: US 2014/0114901 A1
(43) Pub. Date: Apr. 24, 2014

(54) SYSTEM AND METHOD FOR RECOMMENDING APPLICATION RESOURCES

(71) Applicant: CBS INTERACTIVE INC., San Francisco, CA (US)

(72) Inventors: Tushar PRADHAN, San Francisco, CA (US); Sacha Lien, San Fracisco, CA (US); Brooke Bishop, San Francisco, CA (US); Matt Siegel, San Francisco, CA (US)

(73) Assignee: CBS Interactive Inc., San Francisco, CA (US)

(21) Appl. No.: 13/656,512

(22) Filed: Oct. 19, 2012

(51) Int. Cl. G06N 5/02

(52) U.S. Cl. 706/50

(57) ABSTRACT

A system and method to recommend one or more application resources to a user with consideration for the various devices and computing platforms the user operates.

### TECHNICAL FIELD

Embodiments described herein relate to a system and method for recommending application resources.

### BACKGROUND

With the popularity of tablets and mobile devices such as smart phones, consumers increasingly utilize multiple computing devices for varying purposes. For example, it is common for users to carry both a smart phone device and a tablet, or to operate a tablet, smart phone and personal computer at one time in a home environment.

Moreover, the various devices that users typically operate can have varying operating systems, manufacturers and purpose. Many computing platforms provide application stores (e.g., “app stores”), and still further, third party websites and vendors exist that provide applications and resources for use on different computing platforms.

### BRIEF DESCRIPTION OF THE DRAWINGS

FIG. 1 illustrates a system for recommending application resources to users, under various embodiments.

FIG. 2 illustrates a method for programmatically recommending application resources to a user, according to an embodiment.

FIG. 3 illustrates a method for recommending a set of application resources to a user based on an activity that occurs on a particular user device, according to an embodiment.

FIG. 4 illustrates a method for programmatically generating recommendations sets of application resources to a user in response to programmatic triggers that are context-based, according to an embodiment.

FIG. 5A and FIG. 5B illustrate examples in which context-based recommendations can be provided to a user, according to one or more embodiments.

FIG. 6 is a block diagram that illustrates a computer system upon which embodiments described herein may be implemented.

### DETAILED DESCRIPTION

Embodiments described herein include a system and method for recommending application resources to a user.

In particular, some embodiments recommend one or more application resources to a user with consideration for the various devices and computing platforms the user operates.

As an addition or alternative, some embodiments recommend application resources to the user based on a context of user activity. A system or method includes determining a first recommended set of application resources for a user based on a first user activity, and a second recommended set of application resources for the user based on a second user activity.

In variations, the rules or algorithm for determining the recommended set of application resources can vary based on the context of the user activity.

Still further, in some variations, a set of application resources is determined for a user based on consideration of what computing devices and platforms are operated by the user, as well as the context of user activity that triggered the determination of the recommendation (e.g., type of web page the user downloads).

According to one or more embodiments, application resources are recommended to the user. In an embodiment, a trigger identifies a target, corresponding to multiple computing devices of a user that utilize different computing platforms. Information is determined about the target. The information may include a device profile for each of the multiple computing devices associated with the target, where the device profile for each of the multiple computing devices identifies a computing platform for that computing device. A recommended set of application resources is determined for the user based at least in part on the device profiles for each of the multiple computing devices.

In another embodiment, a first trigger is received that identifies a computing device, and a first context for a user activity being performed on the computing device. A device profile is determined for the computing device. The device profile identifies a computing platform for that computing device. A first recommended set of application resources is determined for a user of the computing device based at least in part on the device profile of the computing device and the first context.

In a variation, a second trigger can be received that identifies a second context for a user activity being performed on the computing device. A second recommended set of application resources are is determined for the user of the computing device based at least in part on the device profile of the computing device, as well as the first context and the second context, where the second recommended set of application resources is different than the first recommended set of application resources.

As used herein, the term “application resource” includes applications or programs, scripts, extensions, plug-ins, or configuration data to unlock or enable applications or functionality provided by such applications.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

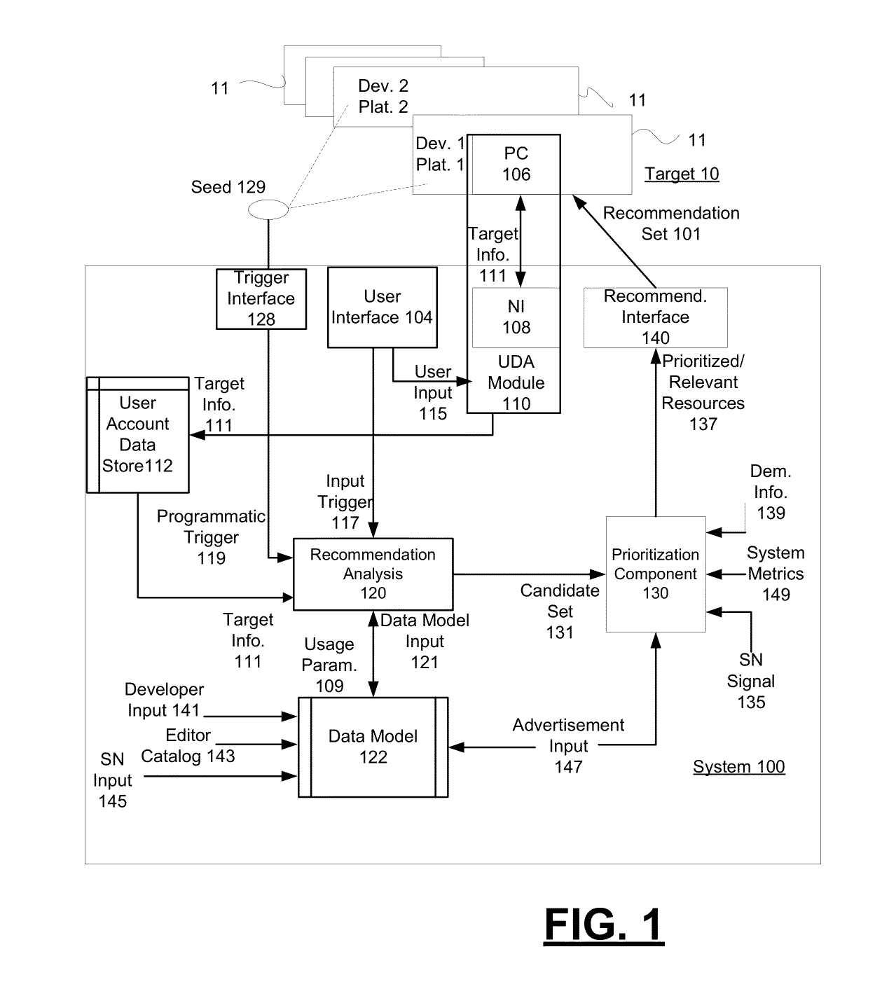

FIG. 1 illustrates a system for recommending application resources to users, under various embodiments. A system 100 such as described in FIG. 1 can be implemented in a variety of context, including as a network service that can communicate with individual devices of a user. In some implementations, system 100 is provided in context of a website, such as a website that provides application downloads or web-based services for end users. In variations, the system 100 can be provided as a service that displays recommendations to a user via an application resident on a user device.

In an embodiment, system 100 includes programmatic components that are implemented as part of a web-service for a grouped set of end user devices (collectively termed “target 10”). For example, a user can operate one or more devices 11, such as, for example, a desktop or personal computer, a mobile computing device (e.g., cellular phone or smartphone), tablet device, and/or an Internet television. In FIG. 1, a target 10 can represent device(s) of a particular user. In some embodiments, the recommended set 101 can be provided with consideration for multiple devices of the particular user-thus, the target 10 can optionally comprise multiple computing devices, including devices that utilize different computing platforms. While an example of FIG. 1 is described with various components or functionality provided on a network (e.g., website), other implementations may distribute some or all of the functionality described to user devices, or to a distributed network environment (e.g., peer-to-peer network).

In one implementation, the system 100 can identify a recommended set 101 to the target 10. The recommended set 101 can identify application resources that a user of the target 10 may appreciate or benefit in using. For example, the recommended set 101 can list applications, extensions or plug-ins that the user can download onto one or more of their respective devices. The recommended set 101 can include links to downloadable files for the user's computing devices. Still further, the recommended set 101 can include data that results or corresponds to a recommended application or service being programmatically or automatically downloaded on one or more devices of the end user.

In some embodiments, the recommended set 101 specifies, for the target 10, applications and/or application resources or services based on user-specific parameters. The user-specific parameters can include, for example, (i) the devices 11 the user operates, (ii) the applications that reside on the various devices 11 of the user, (iii) extensions or plug-ins that exist with applications on one or more of the computing devices, (iv) usage profiles for the devices and/or applications, including what devices are favorites or most recently used, and/or (v) demographic information about the user (e.g., gender, occupation, etc.).

In some embodiments, the target 10 can comprise devices that have different operating systems or operating system kinds, device types, and/or primary uses. Thus, an output of system 100 can make recommendations to the user that are platform-agnostic (e.g., different operating systems or operating system kind). As an addition or alternative, the recommended set 101 can consider individual platforms of a user device. Still further, the recommended set 101 can include platform-specific recommendations for specific devices that are in context of platforms that exist on other devices of the user. Numerous such variations are possible.

In more detail, the components of system 100 can include a user interface 104, a user data acquisition (UDA) module 110, a user account information data store 112, and a recommendation analysis component 120. The UDA module 110 includes functionality that acquires user-specific information relating to applications, data and devices (“target information 111”) that the user operates. The target information 111 originates from one or more individual devices of target 10 as input in determining one or more items of the recommended set 101. The target information 111 can include data that identifies the particular user, either anonymously or otherwise. Additionally, the target information 111 can be used to identify (i) devices or platforms of devices that the user operates, (ii) applications that are resident on the individual devices, (iii) how the user utilizes individual devices or applications, such as applications that the user has most recently used or most frequently uses, and/or (iv) data sets that are resident or associated with applications on user devices (e.g., number of data items for a particular application, size of data in an application library, etc.).

In one implementation, the UDA module 110 is provided as distributed functionality, including a client or device-side programmatic component 106 and a programmatic network interface 108. The device-side programmatic component 106 can be implemented as functionality included in an application resident on one or more of the devices 11. For example, each device 11 in the target 10 can include the programmatic component 106. Alternatively, the programmatic component 106 can reside on a network and utilize or leverage a data set that resides with one or more devices 11 of the target 10.

In variations, the device-side programmatic component 106 can be implemented using scripts or session-based code that runs on one or more of the devices 11. For example, target information 111 can be obtained by scripts that execute through a browser when the user accesses a website. The programmatic component 106 can acquire the target information 111 from the user devices, and can communicate the information 111 to the network interface 108. For example, the programmatic component 106 can acquire the target information 111 by scanning application directories, libraries, or file folders on one or more of the devices 11. As an addition or alternative, the programmatic component 106 can record or otherwise determine metrics about the usage of applications or services on the device. The network interface 108 of the UDA module 110 can receive the target information 111 from the programmatic component 106. In one implementation, the target information 111 is communicated at one time, such as contemporaneously during a session that is triggered by an event for determining recommendations (e.g., user requests input or performs activity to trigger recommendation). Alternatively, the target information 111 is communicated repeatedly as the user updates his or her device sets and develops new habits or preferences for using applications or services.

In some implementations, the target information 111 can identify the user associated with the target, either by user identifier (e.g., by login identifier, social identifier, email address, etc.) or anonymously (e.g., machine or cookie identifier, login identifier, registration identifier, social identifier). For example, in implementations in which the UDA module 110 distributes the programmatic component 106 on multiple devices of the user, the target information 111 can include or be provided with an identifier of the user. As an example, the user may utilize the user interface 104 to login into a service provided by system 100. The login may identify the user, and generate an identifier for the programmatic components 106 that operate on the individual user devices 11. The subsequent operation of the programmatic components 106 on multiple devices 11 of the user results in the target information 111 from the various multiple devices 11 being linked.

As an addition or alternative, the programmatic components 106 can be downloaded with data items such as cookies which identify a user. When a machine on which the cookie resides is used, the cookie links the machine with a site cookie that identifies the machine, as well as a user associated with the machine.

As still another alternative or variation, the UDA module 110 can acquire the target information 111 from user input 115 communicated through, for example, the user interface 104. As an example, the user interface 104 can provide a series of questions or prompts for the user to provide input to. The prompts can solicit information from the user as to, for example, the devices the user operates, the platforms that the devices incorporate, the applications that the user prefers or uses more often than others, etc. In one implementation, user interface 104 corresponds to a web page that the user can access using a browser. In a variation, the user interface 104 can be implemented through an application, which can record and communicate the user response.

The UDA module 110 can store target information 111 acquired for the user with the user account data store 112. In some variations, the target information 111 can be stored in association with other information that may be known about the user. The recommendation analysis component 120 can use the target information 111, as well as other user information (e.g., profile information, such as gender) in determining the recommended set 101. Alternatively, the target information 111 can be obtained and used in real-time to provide the recommended set 101 to the user.

Depending on implementation, the recommendation analysis component 120 can be triggered with either programmatic or user input. In one implementation, an input trigger 117 can be provided by the user operating, for example, the user interface 104. The user can, for example, request through the user interface 104 to receive the recommended set 101. Alternatively, the user can perform some action (e.g., search for applications) or provide some other input that is associated with determining recommendations. In a variation, a programmatic trigger 119 can be signaled through, for example, programmatic seeds 129 (e.g., scripts) that are distributed on, for example, web pages (e.g., download pages, post-download pages, search pages, etc.) that are downloaded by one of the devices 11. In this way, a trigger interface 128 can receive programmatically generated triggers 119 from events such as page downloads or other activities. In variations, the programmatic trigger 119 can be generated in response to events such as (i) user searching or browsing for applications to download, (ii) the user downloading an application, (iii) the user performing some action that is designated to automatically generate the programmatic trigger 119.

In one implementation, the programmatic trigger 119 is generated in response to the user viewing a product page (e.g., a web page where a user can view a product before downloading) before performing an action like downloading an application or data resource. As an alternative or variation, the programmatic trigger 119 can be generated in response to a user completing an action, such as a download of an application or data resource. Still further, in other implementations, the programmatic seed 129 can be incorporated with a search result or other discovery activity to generate the trigger 119.

In some variations, the occurrence of the triggers 117, 119 can result in the recommendation analysis component 120 accessing the target information 111 for the particular user. The recommendation analysis component 120 can use the target information 111 for a particular user to determine usage parameters 109. Examples of usage parameters include lists of devices and platforms of the user, lists of applications the user has on the different devices and platforms, metrics on usage of devices and applications for particular user, etc. As described below, the usage parameters 109 can determine rule sets or algorithms to implement in generating recommendations for application resoures to the user.

Data Model

In an embodiment, the recommendation analysis component 120 references the usage parameters 109 against a data model 122 in order to determine a data model input 121. Thus, the data model input 121 can be specific and responsive to the usage parameters 109. According to some embodiments, the data model 122 lists application resources, associates data or metadata with the application resources, and includes rules or other logic for application resources or sets of application resources. For example, the data model 122 can list application resources from a library, and each application resource can be linked to descriptive text about that application resource, identification of the platform on which the application resource operates, identification of other application resources that are complementary to the application resource, identification of other application resources that are similar (e.g., competitive) to the application resource, and/or one or more categorization labels for the application resource (e.g., productivity, enterprise, etc.). Still further, the application resources can also be linked with real-time or updated data that reflects popularity (e.g., number of times an application has been downloaded), creation or update date, or “buzz” (e.g., as determined from social network feeds). Additionally, the data model 122 may include a series of rules or logical statements that are based on input. Still further, the data model can incorporate or be based on service data signals (e.g., social network signal 135, metrics 149) as described below. In some implementations, application resources can be linked by rule or logic to other application resources based on, for example, categorization parameters of the application resources, or by parameters of the usage profile.

In some implementations, the parameters for the usage profile can show when applications are downloaded by, for example, users that have a particular profile or attribute. As examples, the usage profile may link application resources based on (i) those application resources being downloaded by users that use a common type of computer, (ii) the presence of a particular application or application resource on one of the user's devices, and/or (iii) application resources that reflect or indicate a particular habit or download activity of the user.

Additionally, the identification of such application resources can be made specific to the user profile. For example, users may voluntarily disclose information about their demographics, such as gender, occupation, preferred computing activities, favorite applications, etc. Based on such information, users can be categorized, and linked to one another. Accordingly, data model 122 can maintain datasets that identify users by category, and/or associate applications with particular user categories (e.g., males under the age of 25).

In one variation, the data model may implement an algorithm in which the target information 111 for a particular user is compared against target information of other users to determine similar profiles of users. For example, users may be deemed similar based on determinations such as the number of users having devices of the same platform, the number of users utilizing a same set of applications, or the number of users utilizing a same set of applications on a same machine. When two or more users are linked as having similarities in their respective target information, recently added applications or application resources on the device 11 of one user can be used as a basis for a recommendation to the other user.

The data model 122 can be influenced or configured via input from various sources. In one implementation, at least some aspects of the data model 122 can be based in part on a developer input 141 and/or an editor input 143. The developer input 141 can correspond to associated data, tags, descriptions or links provided by developer who provides the application resource. The editor input 143 can refer to associated data, tags, descriptions or links provided by an editor of the system 100. Additionally, developer/editor input 141, 143 can specify rules or conditions that link applications with one another. Such relevancy can be based on a variety of parameters, such as (i) identification of application resources that are similar in functionality or use so as to be competitive with one another, or (ii) identification of application resources that are complementary, such as by providing added functionality or added usage (e.g., browser plug-in variation of a downloaded application, application extension, cross-platform variation, etc.). Thus, for example, the developer/editor input 141, 143 can also specify complementary applications, data resources or services, such as (i) cross-platform complements, in which an application on one computer/platform can link with (e.g., use same online account or resource) or share data resources with applications on another computer/platform, (ii) alternatives, such as applications that are competitive to other applications that are available for download, and/or (iii) purchase or download complements, where the developer can specify applications that augment or enhance the functionality of another application. In this way, developer/editor input 141, 143 can link application resources for the purpose of making recommendations, even in instances when the linked applications are provided by different entities (e.g., such as when two developers are competitors).

Still further, developer/editor input 141, 143 can be used to tag application resources with categories that reference usage profile and/or user profiles. In such implementations, for example, usage and/or user profiles can be represented by labels, and a developer/editor input 141, 143 can be used to associate application resources with such labels when the labels are known about a particular user interaction.

As another addition or alternative, a social network signal 145 can be used to determine rules or conditions for determining complements or recommendations. The social network signal 145 can utilize suggestions, recommendations (e.g., number of likes) or sentiments determined form social networking feeds (TWITTER, FACEBOOK, etc.) in order to link applications with other application resources, with usage profiles, or with user profiles.

In some embodiments, the recommendation analysis component 120 can determine a candidate set of recommendation items 131. The candidate set of recommendation items 131 can be filtered and/or ranked by the prioritization component 130.

Ranking/Filtering of Recommendation Items

According to some embodiments, prioritization component 130 can utilize various service data signals in order to perform the filtering/ranking. The service data signals can include demographic information 139, where the candidate set of recommendation items 131 is filtered or ranked based on, for example, a gender of the user, occupation of the user, a perceived affluence of the user, and/or a preference of the user as to a particular type of computing activity (e.g., gaming, business, preferences to a particular platform, etc.). The external signals can also include metrics such as popularity (most-downloaded), trending use metrics (e.g., application resources with the greatest increase in downloads), and/or most recently downloaded or mostly recently updated applications.

In some implementations, the various signals described herein can be selected/weighted based on a context in which a recommendation is to be made. For example, a first set of signals can be selected for a first context (e.g., application download page, activity on first activity/platform), and a second set of signals can be selected for a second context (e.g., post-download page, activity on second device/platform). The variation between the first and second set of signals can include constituents of the set (i.e., what signals are used) and/or weights amongst signals in use.

In some implementations, the service data signals can also be used to rank or filter items from the candidate set 131 of application resources. In particular, as described below, one or more social networking signals 135 can be incorporated into the recommended set 101. As described below, the social networking signals can identify, for example, popularity of application resources, trends in application resources, or sentiment for application resources.

Still further, as described below, metrics 149 regarding activity on system 100 (e.g., through downloading of application resources by a population of users) can be determined and used to prioritize the candidate set 131 of application resources.

Social Networking Signals

In more detail, some embodiments can also utilize social networking signals for a variety of purposes in generating recommendations to users. Among the users, the social networking signal 135 (e.g., popularity, trends, sentiment, etc.) can be used to rank or filter application resources from the candidate set of application resources 131. In some variations, the social networking signal (e.g., popularity, trends, sentiment, etc.) can be used to generate the recommended set, or the candidate set 131.

More specifically, the social networking signal 135 can be used to determine social popularity about application resources. For example, social networking feeds (e.g., posts generated on sites such as FACEBOOK, TWEETS provided on services from TWITTER, etc.) from social networks such as FACEBOOK or TWITTER, as well as from embedded commentary provided by content items (e.g., news articles, video clips) can be analyzed to determine when specific application resources are mentioned (e.g., by trade name). U.S. patent application Ser. No. 13/563,667, entitled SYSTEM AND METHOD DETERMINING ONLINE SIGNIFICANCE OF CONTENT ITEMS AND TOPICS USING SOCIAL MEDIA (which is hereby incorporated by reference in its entirety); and U.S. patent application Ser. No. 12/950,356, entitled TECHNIQUES FOR RANKING CONTENT BASED ON SOCIAL MEDIA METRICS (which is hereby incorporated by reference in its entirety); include descriptions for various metrics and mechanisms by which social media can be analyzed to determine when specific items are mentioned. Additionally, as described in U.S. patent application Ser. No. 13/563,667 and U.S. patent application Ser. No. 12/950,356, content items relating to application resources, such as articles, blog, video clips entries, etc., can be analyzed for reference to application resources, and social media can be analyzed for reference to such content items. Among other determinations, the social metric analysis can identify application resources that have the most “buzz” (i.e., mentions in posts, page views, or other social metric scores, etc.) in recent social network commentary, those application resources that are popular in terms of being discussed in social metrics, and those applications which are recently trending in “buzz” or newsworthiness. Metrics determined from social commentary (e.g., popularity, trending) can be used to weight or filter items (representing application resources) from the candidate set 131.

The social networking signal 135 can also represent determinations made from sentiment analysis of social commentary and feeds. For example, U.S. patent application Ser. No. 13/098,302, entitled SYSTEM AND METHOD FOR DETERMINING SENTIMENT FROM TEXT CONTENT (which is hereby incorporated by reference in its entirety); and U.S. patent application Ser. No. 13/433,168, entitled DETERMINING SENTIMENT FOR COMMERCIAL ENTITIES (which is hereby incorporated by reference in its entirety); both of which describe techniques for performing sentiment analysis on text content, as well as social media commentary. Sentiment expressed about, for example, application resources or platforms can be used to weight or filter items from the candidate set 131. For example, if social commentary and sentiment indicate that a particular application resource is popular or well liked, the social networking signal 135 can weight or rank such an item above others when converting the candidate set 131 into the recommended set 101.

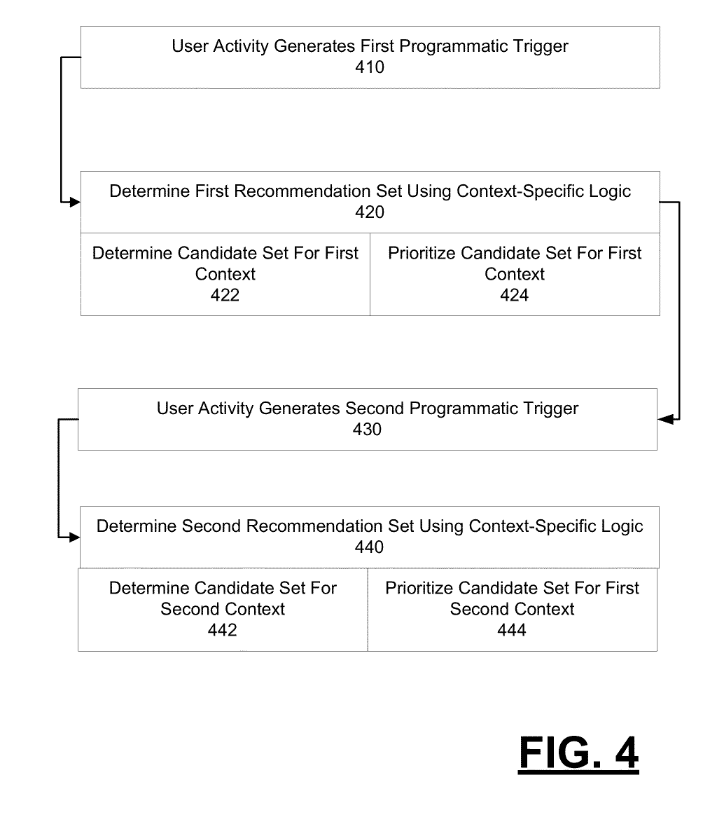

Depending on the context in which the system is to be used, the signals can be selected or weighted based on a variety of factors. Each selection and/or weighting can result in a separate process for determining the candidate set 131. In some implementations, the factors that weight or select the signals are based on the programmatic trigger 119, and optionally, on the context in which the programmatic trigger 119 was generated. For example, the weight for the signals may be varied based on a web page that incorporates the seed 129 for which the programmatic trigger is generated. As described in greater detail by example of FIG. 4, a user can receive a first recommended set 101 when the user activity results in a first type of page download (e.g., download page for application, versus post-download page), and a second recommended set 101 when the user activity results in a second type of page download. Each recommended set 101 can be determined from a different rule set or algorithm that accounts for the context of the user's activity (e.g., what web page the user downloaded).

Various other metrics can be used to determine the candidate set 131 for the recommendation. The system 100 may track, for example, application resources that are most popular, trending in popularity (e.g., change number of downloads over time or velocity metric), most recently updated, or newly released. These metrics can weight or rank what is recommended to the end user.

Prioritization Output

According to one or more embodiments, the prioritization component 130 can output a prioritized set of relevant resources 137 (e.g., applications, data resources, etc.) to a recommendation interface 140. From the prioritized set 137, the recommendation interface 140 can communicate the recommended set of application resources 101 that is based on the prioritized application resources 137. In some implementations, the recommendation interface 140 can correspond to a site page provided by the system 100 which lists applications, data resources or services. Links or other content representing the recommended application resources 101 can also be displayed. In variations, the site page can be provided as a download or product page (e.g., page from which a user downloads an application). Thus, for example, a user can view the recommended set of application resources 101, which can correspond to alternatives or competitive products to the application that the user wishes to download. In variations, the site page can correspond to a post-download page that displays complementary or additional applications, resources or services based on what a user just downloaded.

Still further, the output of the recommendation interface 140 can correspond to an application page or presentation that separately marks or lists applications that are part of the recommended set 101 to the user. As an addition or alternative, the items of the recommended set 101 can be distributed to the user in a variety of context. For example, a user can be displayed a banner that identifies a first recommended application for download based on the context of the user activity. In another instance, another banner can be displayed that identifies a second recommended application for download based on another context of user activity.

As an alternative or variation, the recommendation interface 140 can use alternative mediums or transports to communicate the recommended set 101. For example, the user can be messaged (e.g., email) or provided application content corresponding to the recommended set 101. Still further, in some implementations, the user can specify a setting in which one or more application resources are automatically downloaded, or initiated for download, to one or more of the end user devices based on the determined recommendations.

As examples of one or more described embodiments, in an implementation in which the target 10 includes a single device, the recommended set 101 can be provided as a list of application resources. In an implementation in which the target 10 includes multiple devices, the recommended set 101 can include one or more application resources for a first computing device of the user, and one or more application resources for a second computing device of the user. The recommendations for each computing device can be made at one time (e.g., when the user is operating the first or second computing device), or at different times (e.g., make recommendations to users when they operate the respective computing devices for which the recommendations are being made. As an example, the user can be shown a first list of recommended application resources for a first computer (e.g., tablet), and a second list of recommended applications for a second computer (e.g., personal computer or television). Thus, the user can be provided with a list of programs that the user can download on each of the multiple computing devices.

Advertisement Input

As an addition or variation, the candidate set 131 or recommended set 101 of application resources can include one or more resources that are determined at least in part based on advertisement or sponsorship. In one embodiment, an advertiser input 147 can link an advertiser's application resource with other applications or application tags. For example, the programmatic trigger 119 can specify a tag that identifies one or more sponsored application resources (e.g., application resources which are sponsored and which are relevant to the context identified by the trigger 119). As another variation, the advertiser input 147 can result in sponsored application resources which can inherently have a higher prioritization (e.g., ranking) than non-sponsored application resources.

Methodology

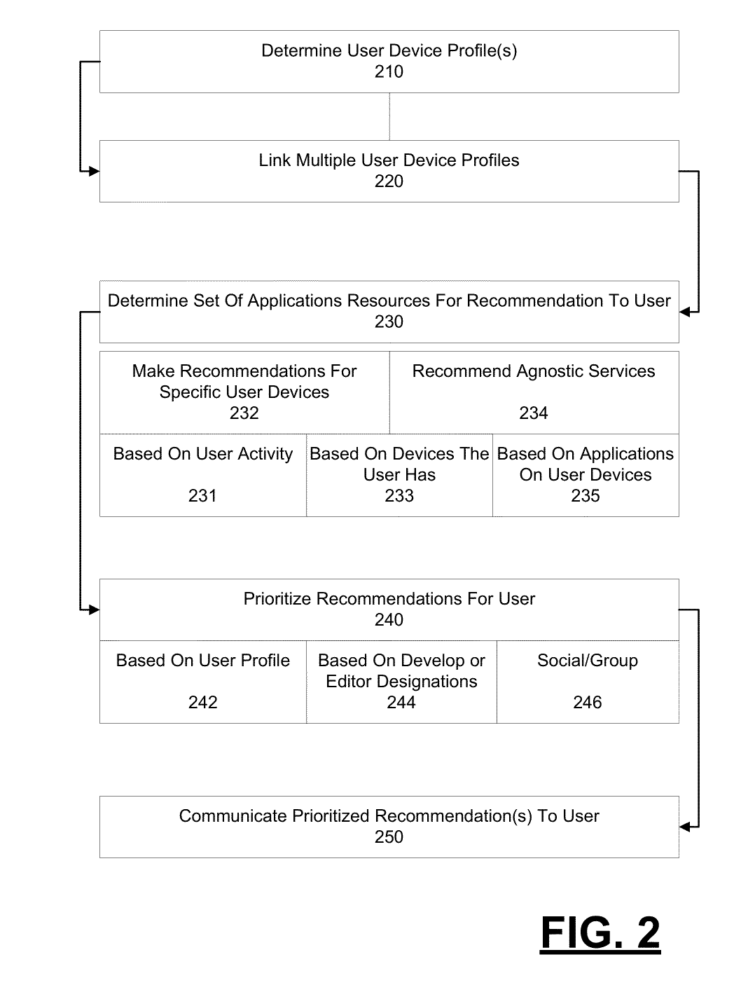

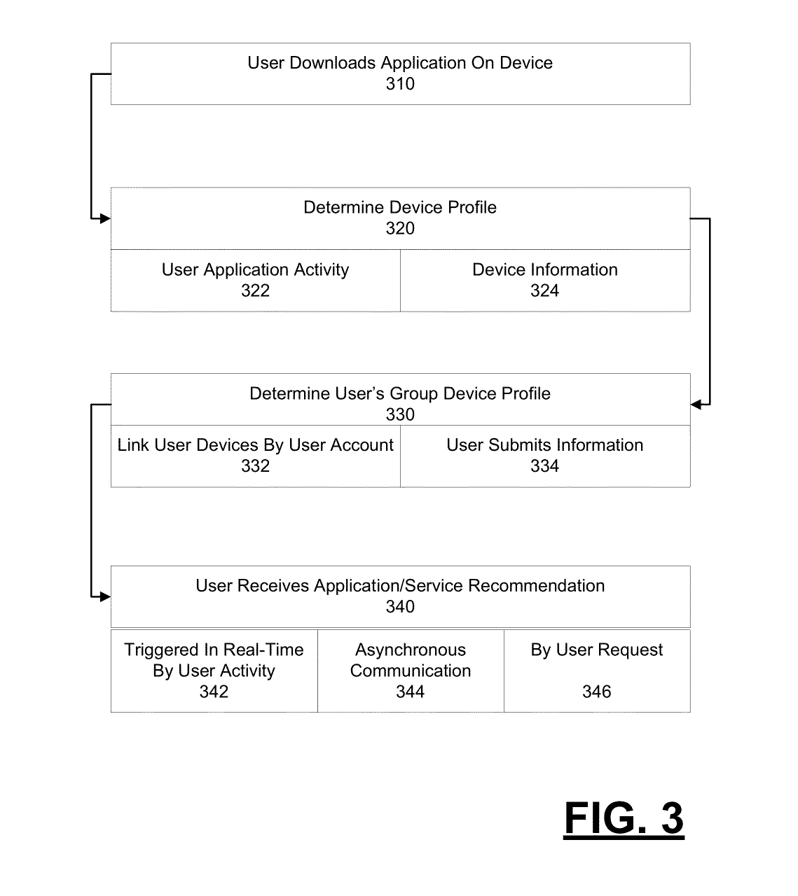

FIG. 2 illustrates a method for programmatically recommending application resources to a user, according to an embodiment. FIG. 3 illustrates a method for recommending a set of application resources to a user based on an activity that occurs on a particular user device, according to an embodiment. FIG. 4 illustrates a method for programmatically generating recommendation sets of application resources to a user in response to programmatic triggers that are context-based, according to an embodiment. In describing methods such as described in FIG. 2 through FIG. 4, reference may be made to elements or components described with FIG. 1 for purpose of describing a suitable element or component for performing a step or sub-step being described.

With reference to FIG. 2, a user's device profile is determined (210). In some variations, multiple device profiles are determined for a user and then linked to one another (220). Still further, in some variations, the user may have multiple devices that include different resident applications and/or platforms. Components that comprise the individual user device profile can include identification of the specific computing device of the user, the platform of the computing device, and/or some or all application resources that are resident on that computing device. As an addition or alternative, a given device profile can include contextual information, such as information about (i) the nature of the computing device, (ii) whether a device is a wireless roaming device or a home computer, (iii) the frequency in which the particular device is used (e.g., primary computing device or one that is sparingly used), or (iv) whether the computing device has multiple accounts on it.

The information for the device profile can be determined from a variety of ways. For example, as described in FIG. 1, a programmatic component 106 (e.g., installed application) may execute on the user's device to scan the memory resources of the device. In this way, the programmatic component 106 can determine, for example, what application resources are resident on the device. The programmatic component 106 can then signal the system 100 target information 111 that identifies, for example, what computing device and platform is in use. In variations, programmatic components can be implemented through scripts that are downloaded on the user device via a web browser. Such scripts can be implemented on a session basis, or more permanently. Cookies or other identifiers associated with the user computing device can link the computing device with system 100, and optionally identify the machine or device to the system. In other variations, the user may be prompted to enter some or all of this information manually using, for example, an interface generated from the system 100.

In some embodiments, the recommendations provided to users are based on considerations of the users' devices and their respective platforms. Accordingly, multiple user device profiles may be attained for a single user. In an embodiment, the multiple user device profiles are linked, so that system 100 is able to identify a group of computing devices for particular user. In order to link the different computing devices, each computing device may signal a cookie that identifies the user (e.g., anonymously) to system 100. For example, each computing device may access system 100 to receive a script or application download which can execute to determine the device profile. The user may login or provide some identifier that enables the system 100 to generate an identifier for the application or script that is downloaded to each computing device. When the device profile information is determined from individual devices, the identifier associated with the particular user account can be communicated from each user device to the system 100 via, for example, use of a site cookie.

In variations, the user can identify his or her devices using, for example, an application interface on one or more of the devices. For example, a mobile computing device may be identified by its associated phone number, while a desktop computer can be identified by a machine identifier. The user can manually operate each device to register with the site, and receive a cookie that subsequently enables data retrieved from that machine to be linked with data from other devices of the same user.

A set of application resources can be determined for recommendation to the user (230). For example, the system 100 can generate a candidate set of recommendations for the user, which can subsequently be prioritized (e.g., ranked or filtered). The application resources can include, for example, applications, extensions or plug-ins to applications, files or data sets for use by applications, or services for applications. The candidate set of recommendations can be specific to individual user devices, despite platform variations amongst the devices of the user (232). For example, if the user has a mobile computing device that operates under a first platform (e.g., iOS by APPLE INC.), and a desktop computer that operates under a second platform (e.g., WINDOWS by MICROSOFT CORPORATION), the candidate set of recommendations can be based off of the platform of the device that triggered the recommendation, as well as the other device from which no trigger was generated.

In the example provided, the recommendation analysis component 120 generates recommendations that take into account the different computing devices that the user operates, even when the user's computing devices utilize different computing platforms. For example, if the user conducts significant messaging activity utilizing a messaging program or service on the first computing device, a complementary messaging application can be recommended to the user for the second computing device, even though the second computing devices has a different platform than the first computing device, and even though the second computing device is not heavily used for messaging purposes.

In variations, the application resources that comprise the recommendations for the user can be platform agnostic services (234). For example, recommendation analysis component 120 can recognize that the user operates multiple computing devices with different platforms, but that the user also has a preference for a particular kind of activity or application. The recommendation analysis component 120 can, for example, identify a platform agnostic service for the particular kind of activity that the user performs. For example, a cloud-based variant to the activity or application can be identified and recommended to the user. As another example, an extension to a browser can be identified, where variations of the browser are available on different platforms.

The recommended set 101 or candidate set 131 that is generated for the different user devices, whether device specific or platform agnostic, can be based on different parameters or signals. In one embodiment, the recommendations (e.g., candidate set 131) are based on user activity (231). For example, the activity that is used to determine the recommendation can be performed on one of the computing devices that is linked to the user. As another example, the activity that is used to determine the recommendation can be performed by the user over a given duration across multiple devices and computing platforms. Thus, activities performed in one of the user's computing devices can affect the determination of items in the candidate set 131 for that computing device, or for one or more other computing devices in the group of devices associated with the user. As another example to the one provided above, if a user operates a mobile computing device (with Platform A) to capture a lot of images, the recommended set 101 or candidate set 131 of application resources can include an application for the user's desktop computer (Platform B) that enables photo editing, photo sharing, or photo product purchasing.

The determination of the recommended set 101 or candidate set 131 can also be based on specific devices or device platforms that the user has in his or her device group (233). For example, if the user has devices that are of different computing platforms, so as to be generally not compatible, the recommended set 101 or candidate set 131 can include conduits or sharing resources between the two platforms or devices.

Still further, the recommended set 101 or candidate set 131 can be determined from consideration of parameters that are based on the applications that are resident on each user device (235). For example, if the user has different applications on the multiple computing platforms that perform a similar function, the recommended set 101 or candidate set 131 can identify application resources (e.g., cloud-based services) that share similar purposes as those particular applications.

In some embodiments, the recommendations for the user are prioritized, and the result is a recommended set 101 (240). The prioritization can include ranking or sorting items in the candidate set 131, so that some of the items are more prominently listed over others (e.g. first on the list). The prioritization can also include filtering some items in the candidate set 131.

According to some embodiments, prioritization of recommendations for the user can be based in a variety of signals. For example, the prioritization component 130 can be based on an output of the recommendation process that is specific to a set of signals and their respective weighs. For example, the prioritization component 130 can utilize signals that are generated from the user profile (242). The user profile can be based on, for example, age, gender, occupation, and/or categorization of the user's computing activity (e.g., light user, gamer). In a variation, the prioritization can be based on developer or editor designations (244). For example, a developer (or advertiser) can pay for priority designations or weights for a period of time.

Still further, the signals for determining the recommendation or prioritization can be based on social commentary (246), such as the metrics described above. Such metrics can include, for example, popularity, sentiment, social trends, etc.

Still further, the signals can reflect metrics that are known to system 100. For example, application resources can be prioritized if the application resources are popular amongst all users, or if the application resources are trending in heavy use. Additional metrics that can be incorporated by the prioritization component 130 include factors such as when the application was last updated, or when the application was created.

In determining the recommendations, the signals can be weighted, based on the metrics that comprise the signals. For example, certain demographics may weight one parameter over another. Thus, for example, if the demographic for the user indicates that the user is a heavy gamer, a gaming application or application resource may be prioritized higher than other resources in the candidate set 131. The recommended set 101 may then prominently include, for example, a gaming application over other resources that may have been recommended to the user, but for the gaming profile associated with that user.

Once the recommended set 101 is determined, the recommended set 101 can be communicated to the user (250). The new mode of communication can vary, depending on implementation of, for example, system 100. In one implementation, system 100 displays recommended set 101 on web pages in connection with the user researching and/or downloading applications from a corresponding website. In such implementations, the recommended set 101 can be provided on, for example, a download page, or a post download page. In variations, the recommended set 101 can be provided to the user in response to their search or browsing activity (e.g., on website of service provided by the system 100).

As noted with some embodiments, the recommended set 101 can be provided responsively, (e.g., in real-time) in response to certain triggers, such as programmatic triggers generated by certain user activity. For example, a user's access to a download page may generate a first programmatic trigger for a first recommended set, while the post-download activity (e.g., rendering of the post download page) can generate a second recommended set. In variations however, the recommended set 101 can be communicated asynchronously in response to programmatic or manual triggers. For example, the recommended set 101 can be messaged to the user, such as in the form of the newsletter.

FIG. 3 illustrates a method for recommending a set of application resources to a user based on an activity that occurs on a particular user device, according to an embodiment. The user can download, for example, an application on a first device (310). In variations, the user can download a script from a website, such as one hosted by system 100, or an affiliate site for the system. The application can be dedicated to determine target information 111 on that device. However, in other variations, the application can include other primary purposes. The application can execute to scan, for example, an application library or an application data set in order to determine the target information 111.

Based on the information determined for the device, the device profile can be determined (320). The device profile can include information about application activity on that device (322). Examples of such activity include the most frequently used application, the most popular applications on the device, or those applications that require most persistent usage or data requirements. The device profile can also include device information, including, for example, the operating system on the device (including type and version), the memory resources, the model or model type of the device, the capabilities of the device and/or other information about the device (324).

The determination of the device profile can be repeated for multiple user devices, and information determined from the multiple devices can be grouped or linked together for the particular user. The linked information or device profiles can be used to determine the user's group device profile (330). In order to determine the group device profile, the user's devices may be linked by, for example, a user account (332). For example, each user device may include a cookie or other identifier that is communicated to the service with the particular device's information. In variations, the user may also submit information that facilitates or identifies the devices to the system 100. Alternatively, some or all of the information that is used to determine the device profiles is received manually from the user (334).

The user can then be provided a set of recommended application resources (340). The recommended set of application resources can identify various application resources, such as by way of providing links for downloading those application resources. In an embodiment, the recommended set can be made in response to, for example, a trigger, such as generated by user activity of a particular type (342). For example a programmatic trigger 119 may be generated by the user downloading a product page. As another variation, the programmatic trigger 119 may also be generated in response to the user downloading an application, such as by on a post-download page.

In variations, the recommended set of application resources 101 can be communicated asynchronously to the user (344), such as through messaging. Still further, the recommended set of application resources 101 may be communicated to the user in response to their request. For example the user may log into a website of system 100 to view what application or application resources are recommended for the user. The recommended set of application resources 101 can also be communicated for different devices of the user at different times, such as at times the user operates each of the computing devices.

As another variation, the user may login to an account on a download application library in order to view a select set of application resources that are recommended to the user for download (346).

FIG. 4 illustrates a method for programmatically generating recommended sets of application resources to a user in response to programmatic triggers that are context-based, according to an embodiment. With reference to FIG. 4, a user may perform a certain activity that generates a first programmatic trigger 119 (410). For example, the user may access an application library and view or render a download page for a specific application. The programmatic trigger 119 may identify the context of the web page. Specifically, the programmatic trigger 119 may carry information that identifies that the user is viewing a download page (a web page containing a link or file for downloading an application resource) for a particular application resource. Alternatively, system 100 may view a cookie (e.g., session cookie) in order to determine that the user has downloaded or is viewing a download page for a particular application resource. This context information (that the user is rendering a download page for specific product) may be incorporated into the programmatic trigger 119. Thus the programmatic trigger 119 can provide identification for the context of a user's activity. For example, the programmatic trigger 119 can identify a download page for a specific application resource that the user is considering downloading.

In response to the first programmatic trigger, the system 100 can generate a first recommended set of application resources using context-specific logic (420). A set of signals and weights can be determined for the user based on a first set of signals and weights for recommending, for example, download resources. In one embodiment, a resulting first recommended set can identify application resources which are relevant to the context of the user activity, as well as to the user device profile or usage profile. In an embodiment, the recommendation analysis component 120, in connection with the data model 122, determines a candidate set 131 that is based on the components of the programmatic trigger 119 (422). Specifically, the candidate set 131 may be made based on an algorithm (e.g., weights of the signals, what signals are selected, rule set) or other logic that seeks to identify competitive or similar application resources to those that the user is contemplating downloading at that download page identified in the programmatic trigger 119. As an addition or alternative, the candidate set of application resources may be ranked or filtered using signals that are context-based for the first programmatic trigger 119 (424). Thus, the determination and/or the prioritization of the recommended set of application resources can be influenced by the context, and affect the output of the system 100 for the end user.

Subsequently, the user may perform a second activity that generates a second programmatic trigger (430). A resulting second recommended set of application resources 101 can be based on a logic that is specific to the current context (440). For example, a second algorithm (e.g., weights for signals, what signals are selected, or rule set) may be used to determine the candidate set 131, from which recommendations are determined (442). As an addition or alternative, the candidate set of application resources may be ranked or filtered using signals that are context-based for the second programmatic trigger 119 (444). As a result, the recommended set of application resources is specific to the context of the current user activity, as well as to the user device profile or usage profile.

### Implementation Example

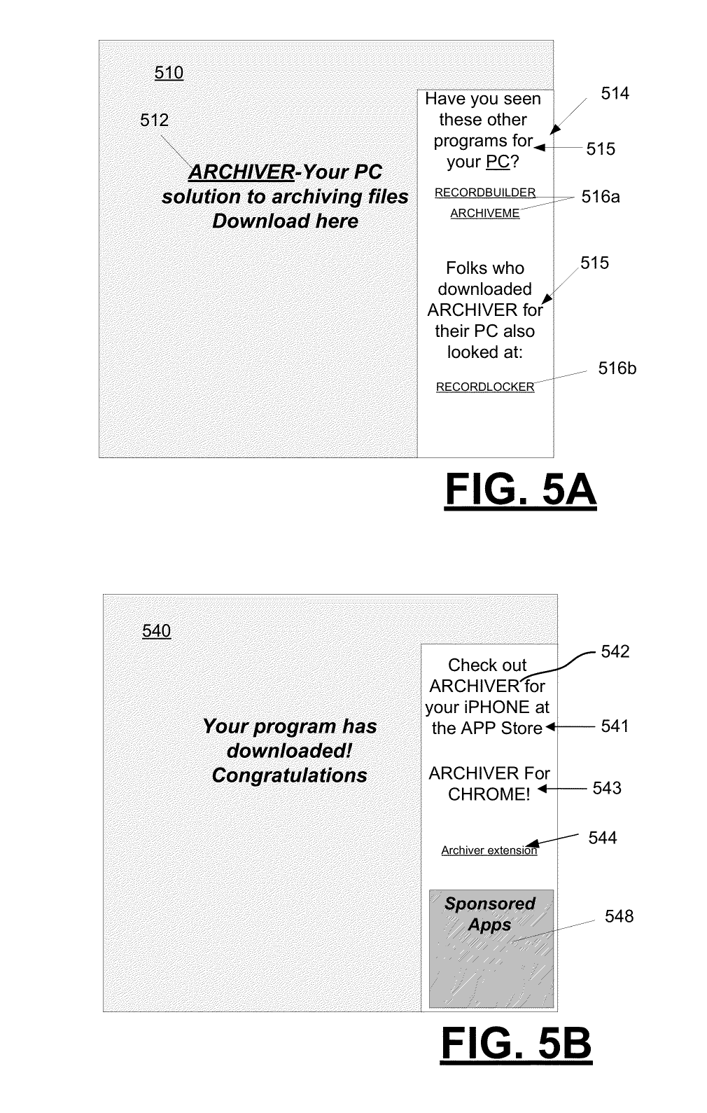

FIG. 5A and FIG. 5B illustrate examples in which context-based recommendations can be provided to a user, according to one or more embodiments. FIG. 5A illustrates a download page 510, on which a file to an application can be accessed via link 512. As described with, for example, an embodiment of FIG. 4, the download page 512 can include an embedded seed for generating the first programmatic trigger. When the download page is rendered on the user terminal, the generated trigger results in the system 100 generating a first recommended set of application resources 514. In the example shown, the recommended set 514 includes content 515 (e.g., text) that provides information as to why the particular application resource is being recommended. The recommended set 514 can be tailored to the context that generated the trigger, as well as to the profiles in use (e.g., device, usage and/or user profiles). Thus, as shown in FIG. 5A, the first recommended set 514 can recognize that the user has yet to perform a download, and the recommended set of application resources can be shown to the user on the basis of providing the user with possible alternatives to consider.

The first recommended set 514 can also be specific to the platform of the user's particular device. For example, the content 515 and the alternative program files 516 can recognize that the user is looking for a program while using a computing device of a particular platform. Alternatively, the first set of recommended application resources 514 can be for a user device other than the one on which the download page 510 is rendered.

In the example of FIG. 5A, the recommended set of application resources 514 can include recommendations 516a that are specific to the platform and determined from logic that includes, for example, developer input, editor input, application resources that are popular for a particular platform of the user, and application resources that are trending (or trending for a particular platform). In the example, the recommended set of application resources 514 can include recommendations 516b which are based on considerations such as matching the user's device profile to other users who have the same device profile. For example, the user can be matched to other users who have the same device platform, and, one of, for example, (i) a same set of applications, (ii) a same set of recent downloads, (iii) similar usage profiles (e.g., favorite applications) and/or (iv) similar user profiles (e.g., gamers).

In the example provided by FIG. 5B, after the user downloads an application resource, a post-download page 540 can embed another seed. The programmatic trigger rendered from the second seed can result in the system 100 generating a second recommended set 542 that is tailored for the context that generated the second programmatic trigger, as well as the device and/or user profiles.

In this way, the programmatic trigger 119 can identify the context (post-download event), such as the application resource that was being considered for download, or the application resource that was downloaded. For example, when the post download page is rendered, the programmatic trigger 119 may signal the system 100, and identify that the event occurred (event being the downloading of a particular application resource). In the context of, for example, the post-download page, the recommended set of application resources provided to the user may include application resources that are complementary to the application that the user just downloaded. For example, the recommended set 542 can include content 541 that informs the user as to other applications the user may be interested (based on knowledge of the user's other device, as well as identification of the application that the user just downloaded), as well as content 543 that identifies other application resources 544 that the user can download immediately.

According to an embodiment such as depicted by FIG. 5A and FIG. 5B, the recommendation analysis component 120 generates an output set of recommended application resources based on a recognition of context in the user's activity. The recommendation analysis component 120 may utilize a rule set or algorithm that is specific to the determined context of user activity, in determining from the data model 122 the candidate set 131. For example, on a download page, the recommended set of application resources (which is based on, or corresponds to the candidate set 131) can include applications that are complementary to one that the user just previously downloaded. As shown by FIG. 5B, for example, the application resources can identify plug-ins or extensions for a particular application resource that the user downloads on a specific device. Alternatively, the recommended set can identify, for example, different variations of the same application resource for other platforms that coincide with devices that the user operates.

Sponsored Application Resources

In the example shown by FIG. 5B, one or more application resources that are recommended to the user can be sponsored applications 548. An advertiser can, for example, purchase advertisement to display application resources as a sponsor in connection with certain activity, such as post-download web pages. An advertiser can pay to provide a sponsored application resource in connection with certain user activity, such as the user's download of a particular application resource. For example, advertisers can bid to appear on the post-download page of popular applications.

Still further, in contrast to conventional advertisements, the advertisement product can correspond to an actual application resource that can be purchased or used in connection with a previously downloaded program, or a previously downloaded program of a particular category. For example, an advertiser can purchase to provide a free version of an application in connection with the download of a specific application or type of application, and then offer full versions of the application for purchase by users who download the free version.

In this way, an advertiser can leverage the popularity of an application resource in marketing, for example, their own application resource. For example, an advertiser can sponsor to provide a free version of a game, in connection with the download page for another game application that is popular. The advertiser can purchase a sponsorship by linking to a tag for a popular game, or to a desired application category (e.g., children games). In variations, the advertiser can purchase a sponsorship by linking to a device or target profile (e.g., users who operate two different devices of specific profiles).

While an example of FIG. 5B illustrates sponsored application resources for a post-download page, other variations can provide sponsored application resources for other contexts. For example, advertisers can purchase to provide sponsored links in connection with a download page for an application resource. To further illustrate, an advertiser can purchase to provide a link to their respective application resource in connection with download pages that identify a particular category, application or other tag. In this way, a user search for an application resource can generate a sponsored link that provides, for example, one sponsored application resource for the user to consider.

Computer System

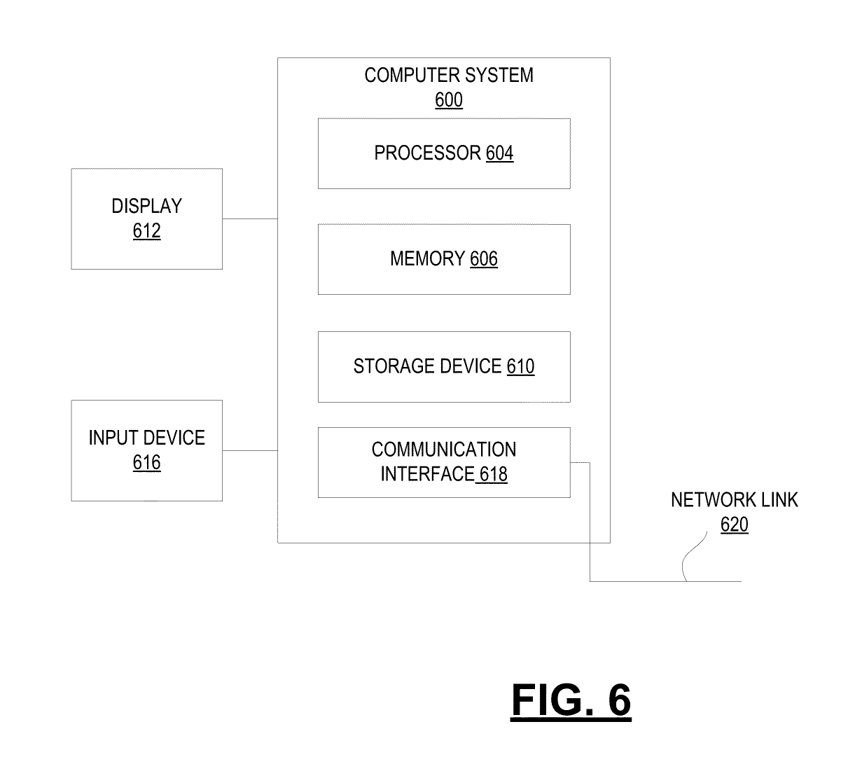

FIG. 6 is a block diagram that illustrates a computer system upon which embodiments described herein may be implemented. For example, in the context of FIG. 1, system 100 may be implemented using one or more computer systems such as described by FIG. 6.

In an embodiment, computer system 600 includes processor 604, memory 606 (including non-transitory memory), storage device 610, and communication interface 618. Computer system 600 includes at least one processor 604 for processing information. Computer system 600 also includes the memory 606, such as a random access memory (RAM) or other dynamic storage device, for storing information and instructions to be executed by processor 604. The memory 606 also may be used for storing temporary variables or other intermediate information during execution of instructions to be executed by processor 604. Computer system 600 may also include a read only memory (ROM) or other static storage device for storing static information and instructions for processor 604. A storage device 610, such as a magnetic disk or optical disk, is provided for storing information and instructions. The communication interface 618 may enable the computer system 600 to communicate with one or more networks through use of the network link 620 (wireless or wireline).

Computer system 600 can include a display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in the memory 606. Such instructions may be read into memory 606 from another machine-readable medium, such as storage device 610. Execution of the sequences of instructions contained in memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for recommending an application resource, the method being implemented by one or more processors and comprising:
receiving a trigger that identifies a target, the target being associated with multiple computing devices that utilize different computing platforms;
determining information about the target, including a device profile for each of the multiple computing devices associated with the target, the device profile for each of the multiple computing devices identifying a computing platform for that computing device; and
determining a recommended set of application resources for the user based at least in part on the device profiles for each of the multiple computing devices.

2. The method of claim 1, further comprising determining, from the trigger, a context for the user activity being performed on at least one of the multiple computing devices; and
wherein determining the recommended set of application resources is also based at least in part on the context of the user activity.

3. The method of claim 2, wherein the context is based on a web page from which the trigger is generated.

4. The method of claim 2, wherein the context is based on a user activity from which the trigger is generated.

5. The method of claim 1, wherein determining the recommended set of application resources includes recommending a first application resource for a first computing device of the target that utilizes a first computing platform, and a second application resource for a second computing device of the target that utilizes a second computing platform.

6. The method of claim 5, wherein the first application resource and the second application resource are provided from a same developer.

7. The method of claim 5, wherein the second application resource is a browser plug-in or extension variation of the first application resource.

8. The method of claim 1, wherein recommending the set of application resources includes recommending an application resource for a specific computing device of the target, based on the device profiles of two or more of the multiple computing devices.

9. The method of claim 1, wherein the device profile for each of the multiple computing devices includes a list of applications that are resident on that computing device.

10. The method of claim 1, wherein determining information about the target includes determining a usage profile for each of the multiple computing devices, and wherein recommending the set of application resources is based on the usage profile determined for each of the multiple computing devices.

11. The method of claim 1, wherein determining the set of recommended resources includes recommending one or more applications for each of at least two computing devices of the target that operate using different computing platforms.

12. The method of claim 1, wherein determining the recommended set of application resources includes (i) determining a candidate set of application resources, and (ii) determining the recommended set of application resources by prioritizing the candidate set, and
wherein prioritizing the candidate set is based on a set of service data signals that is determined from a group of users.

13. The method of claim 12, wherein the set of service data signals includes a signal that identifies one or more application resources that are most popular or trending in popularity amongst a group of users.

14. The method of claim 12, wherein the set of service data signals includes information determined from social media.

15. The method of claim 12, wherein prioritizing the candidate set includes ranking the set of resources.

16. The method of claim 12, wherein prioritizing the candidate set of resources includes filtering the set of resources.

17. The method of claim 12, wherein the set of service data signals includes data indicating a popularity or sentiment of individual application resources one or more social networking sources.

18. The method of claim 1, wherein the set of service data signals includes multiple components, and wherein the method further comprises weighting the components that comprise the service data signals.

19. The method of claim 12, further comprising determining demographic information for a user, and wherein prioritizing the candidate set includes ranking or filtering the candidate set based on the demographic information of the user.

20. The method of claim 1, further comprising providing the user with a list of programs to download on each of the multiple computing devices.

21. A method for recommending a resource, the method being implemented by one or more processors and comprising:
receiving a first trigger that identifies a computing device and a first context for a user activity being performed on the computing device;
determining a device profile for the computing device, the device profile identifying a computing platform for that computing device; and
determining a first recommended set of application resources for a user of the computing device based at least in part on the device profile of the computing device and the first context.

22. The method of claim 21, further comprising:
receiving a second trigger that identifies a second context for a user activity being performed on the computing device, and
determining a second recommended set of application resources for the user of the computing device based at least in part on the device profile of the computing device, the first context and the second context, the second recommended set of application resources being different than the first recommended set of application resources.

23. The method of claim 22, wherein the first recommended set of application resources is determined using a first algorithm or set of rules that is determined from the first context, and wherein the second recommended set of application resources is determined using a second algorithm or set of rules that is based on the second context.

24. The method of claim 23, wherein the first context is based on a user downloading a first type of web page, and wherein the second context is based on the user downloading a second type of web page.

25. The method of claim 24, wherein the first context corresponds to a download page for a corresponding application resource, and the second context corresponds to a post-download page for a corresponding application resource that was previously downloaded.

26. The method of claim 25, wherein the first set of recommended application resources identifies one or more alternative application resources to the corresponding application resource, and the second recommended set of application resources identifies one or more application resources that are complementary to the corresponding application resource that was previously downloaded.

27. The method of claim 26, wherein the second recommended set of application resources identifies a plug-in or extension variation to the corresponding application resource that was previously downloaded.

28. The method of claim 26, wherein the second recommended set of application resources identifies an alternative version of the application resource that was previously downloaded for a different computing platform.
